(19) United States
(12) Patent Application Publication
(10) Pub. No.: US 2005/0240446 A1
(43) Pub. Date: Oct. 27, 2005

(54) System and method for determining the qualifications of a patient for a specific care and quantifying the appropriateness of its application

(75) Inventor: Dale Berry, Bloomington, MN (US)

Correspondence Address: STROOCK & STROOCK & LAVAN LLP, 180 MAIDEN LANE, NEW YORK, NY, 10038, US

(73) Assignee: Hanger Orthopedic Group, Inc.

(21) Appl. No.: 11/109,063

(22) Filed: Apr. 19, 2005

Related U.S. Application Data
(60) Provisional application No. 60/563,929, filed on Apr. 20, 2004.

(51) Int. Cl. G06F 17/60

(52) U.S. Cl. 705/3; 705/10

(57) ABSTRACT

A system and method is provided for determining a patient's need for a specific clinical care or component and its appropriateness for the patient's needs. The system and method can comprise gathering scores for a plurality of categories having one or more questions directed to one or more characteristics of a patient. The questions can generally be directed toward understanding the patient's needs and the compatibility of the specific clinical care and the patient. The scores for each category can be used to obtain a final score, which is then evaluated to determine the qualifications of the patient for the specific care or component.

### CROSS-REFERENCE TO RELATED APPLICATION

This application claims the benefit of U.S. Provisional Application Ser. No. 60/563,929, filed Apr. 20, 2004, entitled SYSTEM AND METHOD FOR DETERMINING THE QUALIFICATIONS OF A PATIENT FOR A SPECIFIC CARE AND QUANTIFYING THE APPROPRIATENESS OF ITS APPLICATION, which is incorporated entirely herein by reference.

### FIELD OF THE INVENTION

The invention relates generally to a system and method for determining the necessity and appropriateness of a specific care, such as a clinical care or prosthetic or orthotic component (“component”) for a patient. The present invention also relates to a system and method for obtaining a numerical value for use in determining whether or not a specific care or component is necessary and recommended for the patient.

### BACKGROUND OF THE INVENTION

The decision to apply a specific clinical care or component, such as a prosthetic device, has historically been based upon the personal experience and opinion of the treating physician and/or prosthetist. This creates a challenge for the insurance company/industry because no specific scientific standards or guidelines are present to clearly disseminate which component would be appropriate for each specific patient. The present invention is designed to address this issue by providing a system and method for more objectively assessing the patient's needs, activities and functional abilities to create a quantifiable numerical value and/or range to establish each patient's clinical requirements to justify application of the care and/or component.

Accordingly, it is desirable to provide a system and method for ascertaining a numerical value or range for a patient for a specific care or component signifying to what extent, if at all, the specific component or care is recommended for that particular patient.

### SUMMARY OF THE INVENTION

Generally speaking, the present invention is directed towards a system and method for determining a patient's need for a specific clinical care or component and its appropriateness for the patient's needs. In accordance with one aspect of the invention, a set of questions for a plurality of categories is generated, wherein the answers are numerically weighted. The questions generally are directed toward understanding the patient's needs and the compatibility of the specific clinical care and the patient. In one embodiment, the categories are directed to the patient's daily activities, the patient's physical capabilities related to Medicare functional level (or K-level) requirement, the patient's physical condition related to strength and mobility of the joints and/or limbs, and the patient's special conditions or challenges that may weigh upon the patient's need for the clinical care or prosthetic component.

Accordingly, it is an object of the invention to provide a system and method for determining whether or not a patient should receive a specific component or care.

It is another object of the invention to provide a system and method for establishing a numerical value or range representing whether a component or care is recommended for a patient.

Yet another object of the invention is to provide a system and method for obtaining an appropriate global evaluation of a patient's abilities and needs.

Another object of the invention is to provide a set of questions directed to a variety of categories regarding the patient's physical condition and needs for a specific component or care.

Still another object of the invention is to provide a set of questions directed to the benefits the patient can obtain from the specific component or care.

Other objects, features, characteristics and advantages of the present invention will become more apparent upon consideration of the following detailed description with reference to the accompanying drawings, all of which form a part of this specification.

### DETAILED DESCRIPTION OF THE PREFERRED EMBODIMENTS

The invention relates generally to a system and method for determining a patient's need for a specific care or component and its appropriateness for the patient's needs. The present invention also relates to a system and method for obtaining a global evaluation of a patient's abilities and needs and using the information obtained to determine the appropriateness and necessity of a specific care or component for the patient.

In accordance with an embodiment of the invention, a plurality of categories are provided, each comprising a set of questions. Preferably the categories relate to the patient's abilities, activities and physical condition, preferably including specific medical conditions that may affect the patient's needs for the care or component. Each category can comprise one or more specific methods of scoring the patient. Each method of scoring the patient is preferably common to either the category as a whole or to certain questions within the category. Accordingly, each category can comprise either one or a combination of more than one methods of scoring the patient. Preferably, each category uses one method of scoring common to the category as a whole.

One example of a method of scoring the patient comprises a range of points, such as points ranging from 0 to 4, according to the answers given to the questions. Another example of a method of scoring the patient comprises a predetermined point value assigned for each question answered a certain way. The questions and points can be weighed a certain way in order to obtain the most accurate and representative final score. For example, a positive answer to a question can account for 3 points whereas a positive answer to another question can account for 1 point.

One possible category can be directed to the patient's daily activities that the patient is expected to perform or performs on a regular basis. The score for this category preferably helps to identify the patient's specific needs and therefore can indicate the specific style and type of prosthetic device required.

Another possible category can be directed to the patient's functional abilities and capabilities as related to the Medicare functional level (or K-level) requirements. The score for this category preferably helps to identify the specific abilities or the potential of the patient to accomplish certain functions as related to the Medicare functional levels.

Yet another possible category can be directed to the patient's physical capabilities, preferably indicating the patient's physical condition that weigh upon the patient's need for the care or component, such as strength and mobility of the primary joints and limbs required to effectively utilize the component, such as a prosthetic device. For example, certain prosthetic devices are geared toward providing stability and security. A person who has weaker joints and muscles would require such a device more than a person with stronger joints and muscles. By determining the patient's physical conditions, this category can help identify desirable as well as unnecessary features of the device.

Special consideration for certain conditions, such as medical conditions, can also comprise a category. For example, the patient's special conditions or challenges can affect the patient's need or compatibility with the device. For example, certain conditions that the patient possesses may require higher levels of security, stability or function from a prosthetic device in order to enable to the patient to accomplish the patient's daily activities.

An embodiment comprising the four sample categories discussed above is illustrated in the following Example 1, wherein the prosthetic device is a microprocessor controlled knee component having a servomotor, or referred to herein as “microprocessor knee servomotor” or “MPK”. Example 1 comprises of four categories: Activities of Daily Living (ADL), Functional Capabilities, Prosthetic Reliance and Special Considerations.

Tables 1, 3, 5 and 7 show sample questionnaires for each category of Example 1 and Tables 2, 4, 6 and 8 provide the purpose and rationale for each question, respectively.

TABLE 1
Activities of Daily Living Evaluation

| To accomplish Activities of Daily Living the | | | | 3-4 times a | 3-4 times a | |
|---|---|---|---|---|---|---|
| patient requires the ability to: | | Never | Rarely | Month | Week | Daily |
| 1. | Walk with variable cadence (change | □ 0 | □ 1 | □ 2 | □ 3 | □ 4 |
| | walking speeds) | | | | | |
| 2. | Walk a distance greater than 400 yards | □ 0 | □ 1 | □ 2 | □ 3 | □ 4 |
| 3. | Walk on uneven terrain (gravel, grass, | □ 0 | □ 1 | □ 2 | □ 3 | □ 4 |
| | curbs) | | | | | |
| 4. | Walk up and down stairs | □ 0 | □ 1 | □ 2 | □ 3 | □ 4 |
| 5. | Walk up and down ramps | □ 0 | □ 1 | □ 2 | □ 3 | □ 4 |
| 6. | Carry or lift items (i.e. books, infant, | □ 0 | □ 1 | □ 2 | □ 3 | □ 4 |
| | groceries etc.) | | | | | |
| 7. | Walk in public areas or crowds | □ 0 | □ 1 | □ 2 | □ 3 | □ 4 |
| 8. | Get in and out of a car | □ 0 | □ 1 | □ 2 | □ 3 | □ 4 |
| 9. | Bend, kneel or stoop | □ 0 | □ 1 | □ 2 | □ 3 | □ 4 |
| 10. | Walk, stand or work in confined areas (i.e. | □ 0 | □ 1 | □ 2 | □ 3 | □ 4 |
| | push a vacuum cleaner, cook in a kitchen, | | | | | |
| | work in a workshop, behind a desk or in a | | | | | |
| | laboratory) | | | | | |
| | ADL Score | | | | | |

The questions posed in the sample Activities of Daily Living category of Example 1 preferably are directed to the specific activities commonly performed by the patient on a regular basis to determine whether or not the device can meet the needs created by the activities. Preferably, these questions can also help determine whether or not certain benefits provided by the device are necessary. For example, if a simple device and a complicated device equally meet a patient's needs, the complicated device may not be necessary and therefore will not be as recommended as the simple device. The score for each question and category can preferably indicate which device is preferred. In the example of Table 1, an ADL score of each question represents the following:

| ADL Score | Rating | Designates |
|---|---|---|
| 0 | Never | Microprocessor Knee not required |
| 1 | Rarely | Microprocessor Knee potential |
| 2 | 3-4 Times a Month | Microprocessor Knee considered |
| | | beneficial |
| 3 | 3-4 Time a Week | Microprocessor Knee recommended |
| 4 | Daily | Microprocessor Knee indicated |

By identifying the patient's specific needs, this category directed to the patient's daily activities could preferably indicate the specific style and type of prosthetic device required.

TABLE 2
Justification and Rationale for the ADL questions

| ADL Questions | Justification and Rationale |
|---|---|
| 1. Walk with variable cadence | The speed of the microprocessor knee servomotor allows it to close the |
| (change walking speeds) | flexion and extension valves very rapidly in response to the microprocessor |
| Cadence Score Question | commands, which are sent 50 times per second. When the valves are |
| | nearly closed the microprocessor knee dampening force becomes very high, |
| | making rapid walking and even running possible. This ability to “tune” |
| | microprocessor-controlled prosthetic knees to the individual's unique gait |
| | pattern has been shown to result in the widest range of cadences available |
| | in any prosthetic knee, and to increase amputee confidence, comfort and |
| | functional levels. |
| 2. Walk a distance greater than 400 | Scientific studies have suggested that the resulting gait with a |
| yards | microprocessor knee is more natural, symmetric, and therefore more energy |
| Cadence Score Question | efficient. This reduction of energy consumption will greatly prolong the |
| | time it takes the amputee's muscles to fatigue. This creates a positive |
| | effect by maintaining greater muscle strength and resulting control of the |
| | prosthesis for a longer period of time. |
| 3. Walk on uneven terrain (gravel, | The microprocessor knee servomotor readjusts the hydraulic flexion |
| grass, curbs) | resistance from maximum powerful stance flexion resistance to nearly |
| | effortless knee bending to initiate pre-swing in less than 120 thousandths of |
| | a second. This feature offers secure stumble-recovery capabilities by |
| | ensuring optimum knee resistance and stability in the event of a mis-step or |
| | stumble. |
| 4. Walk up and down stairs | The stance flexion-yielding rate can be used to decelerate the prosthesis |
| | while descending stairs. The microprocessor stance control and stumble |
| | recovery settings provide optimum resistance for decelerating knee flexion |
| | to enable step-over-step descending of stairs. The advanced stumble |
| | recovery sensor provides maximum stance and stability control to eliminate |
| | premature knee flexion for ascending stairs. |
| 5. Walk up and down ramps | The advanced stumble recovery sensor combined with the stance flexion |
| | design enables the wearer to initiate heel strike during the gait cycle with |
| | the knee in a natural and flexed position. This “stance-flex” feature with |
| | “flexion dampening” mimics the normal gait cycle of the anatomical knee. |
| | The flexion at mid-stance reduces stress and strain to the hip and lower |
| | back while maintaining a smooth transitional pathway for the body's center |
| | of gravity to reduce energy consumption while providing optimal stability |
| | and security to ascend and descend ramps. |
| 6. Carry or lift items (i.e. books, | Independent software-modulated control of swing phase extension |
| infant, groceries etc.) | resistance, adjusted 50 times per second, means that the artificial limb is |
| | fully extended just prior to initial contact every time, with no conscious |
| | effort by the amputee, regardless of the gait speed or ground conditions. |
| | Independent scientific studies have shown that such optimized swing phase |
| | timing translates into greater confidence in the prosthesis, reduced risk of |
| | stumbling, and a more energy-efficient gait. |
| 7. Walk in public areas or crowds | With the onboard computer continually assessing the amputee's gait and |
| Cadence Score Question | walking conditions, it significantly reduces stress and anxiety for the |
| | patient, as he/she does not need to continuously and consciously control all |
| | movements of the knee with muscular control. This contributes to a |
| | significant reduction in overall energy consumption. |
| 8. Get in and out of a car | The microprocessor knee is designed to allow the individual to bear weight |
| | on the prosthesis while it is in a flexed position. This unique feature |
| | enables optimal resistance to knee flexion while entering and exiting a car. |
| | This resistance to knee flexion on a bent knee greatly increases the security |
| | and stability of the knee and significantly reduces strain and stress on the |
| | lower back and sound limb and also reduces the dependence on the upper |
| | limbs to support the body while entering or exiting a car. |
| 9. Bend, kneel or stoop | The microprocessor knee is designed to allow the individual to bear weight |
| | on the prosthesis while it is in a flexed position. This unique feature |
| | enables optimal resistance to knee flexion while bending the knee to |
| | achieve a seated position. This resistance greatly reduces the stress and |
| | strain on the sound limb and lower back, as the wearer is able to use both |
| | lower limbs to achieve a seated position. |
| 10. Walk, stand or work in confined | The electronically controlled flexion valve, adjusted 50 times per second, is |
| areas (i.e. push a vacuum cleaner, | automatically fully opened during pre-swing. As a result, the |
| cook in a kitchen, work in a | microprocessor knee is extremely easy to flex at slow speeds and in |
| workshop, behind a desk or in a | confined areas. |
| laboratory) | |

TABLE 3
Functional Score
Functional Capabilities

| | | | | Exhibits | | |
|---|---|---|---|---|---|---|
| | | Not | | ability to | Can | Presently does |
| Patient has the ability to: | | Possible | Potential | accomplish | accomplish | on daily basis |
| 11. | Transfer without assistive devices | □ 0 | □ 1 | □ 2 | □ 3 | □ 4 |
| 12. | Ambulate on level surfaces at fixed cadence | □ 0 | □ 1 | □ 2 | □ 3 | □ 4 |
| 13. | Traverse low level environmental barriers | □ 0 | □ 1 | □ 2 | □ 3 | □ 4 |
| 14. | Ambulate with variable cadence | □ 0 | □ 1 | □ 2 | □ 3 | □ 4 |
| 15. | Ambulate at a faster than baseline rate (fast walk | □ 0 | □ 1 | □ 2 | □ 3 | □ 4 |
| | or jog) | | | | | |
| | Functional Capabilities Score | | | | | |

The questions posed in the sample Functional Capabilities category of Example 1 are preferably directed to the patient's capabilities as related to the Medicare functional level requirements. The score of each question represents the following:

| Functional | | |
|---|---|---|
| Score | Rating | Designates |
| 0 | Not Possible | Microprocessor Knee not required |
| 1 | Potential | Microprocessor Knee potential |
| 2 | Exhibits ability | Microprocessor Knee considered |
| | to accomplish | beneficial |
| 3 | Can Accomplish | Microprocessor Knee recommended |
| 4 | Presently does on | Microprocessor Knee indicated |
| | a daily basis | |

TABLE 4
Justification and Rationale for the Functional Capabilities questions

| Functional Question | Justification and Rationale |
|---|---|
| 11. Transfer without assistive devices | The ability to transfer without assistive devices is a fundamental |
| | requirement that a patient must be able to demonstrate to be considered a |
| | candidate for prosthetic rehabilitation. |
| 12. Ambulate on level surfaces at | The electronically controlled flexion valve, adjusted 50 times per second, is |
| fixed cadence | automatically fully opened during pre-swing. As a result, the |
| | microprocessor knee is extremely easy to flex at slow speeds and at a fixed |
| | cadence. |
| 13. Traverse low level environmental | The microprocessor knee servomotor continuously adjusts the hydraulic |
| barriers | flexion resistance and stance flexion resistance to enable the knee to |
| | immediately engage a knee stability stance setting in the event of a slip or |
| | loss of balance. This feature will ensure the knee is always stabilized in the |
| | optimum setting to prevent the knee from collapsing in rapid flexion while |
| | negotiating environmental barriers such as curbs, steps and debris. |
| 14. Ambulate with variable cadence | The swing phase control characteristics of the microprocessor knee reduce |
| Cadence Score Question | the amount of excess effort the amputee must expend to walk a given |
| | distance. The adjustable “dynamic factor” allows the microprocessor knee |
| | to be optimized for all gait patterns from the very casual “strolling” style to |
| | very aggressive “athletic” movements. |
| 15. Ambulate at a faster than baseline | The enhanced stance phase control, combined with the superior swing |
| rate (fast walk or jog) | function increases the amputee's confidence and functional capabilities in |
| Cadence Score Question | the prosthesis. Outcome studies have indicated that microprocessor knee |
| | wearers have increased their activity level and range of activities |

TABLE 5
Prosthetic Reliance Evaluation

| Patient Limb/Joint Strength | | Normal | Good | Fair | Poor | Trace |
|---|---|---|---|---|---|---|
| 16. | Amputated side hip extension | □ 0 | □ 1 | □ 2 | □ 3 | □ 4 |
| | (Bilateral AK patient . . . Left side hip extension) | | | | | |
| 17. | Sound side hip extension | □ 0 | □ 1 | □ 2 | □ 3 | □ 4 |
| | (Bilateral AK patient . . . Right side hip extension) | | | | | |
| 18. | Sound side knee extension | □ 0 | □ 1 | □ 2 | □ 3 | □ 4 |
| | (Bilateral AK patient . . . score 4) | | | | | |
| 19. | Sound side Ankle Plantar/Dorsi | □ 0 | □ 1 | □ 2 | □ 3 | □ 4 |
| | Flexion | | | | | |
| | (Bilateral AK or AK/BK patient . . . score 4) | | | | | |
| 20. | Upper Extremity Strength | □ 0 | □ 1 | □ 2 | □ 3 | □ 4 |
| | Prosthetic Reliance Score | | | | | |

The questions posed in the sample Prosthetic Reliance category of Example 1 are preferably directed toward the patient's level of dependence on the prosthesis, for example, for stability and function based upon physical strength and condition of certain joints and muscles required to control the device such as a prosthetic device. Patients with lower physical strength capabilities can receive higher scores in this category, based on the rationale that an individual with stronger limbs and joints may need to rely less on the prosthesis for stability and function, whereas a person with weaker joints and muscles may require enhanced levels of prosthetic stability, security and function in order to accomplish activities of daily living and therefore would have higher prosthetic reliance scores. Accordingly, the score for each question in the sample Prosthetic Reliance category of Example 1 represent the following:

| Prosthetic | | |
|---|---|---|
| Reliance Score | Rating | Designates |
| 0 | Normal | Microprocessor Knee not essential |
| 1 | Good | Microprocessor Knee potential |
| 2 | Fair | Microprocessor Knee considered beneficial |
| 3 | Poor | Microprocessor Knee recommended |
| 4 | Trace | Microprocessor Knee indicated |

TABLE 6
Justification and Rationale for the Prosthetic Reliance questions

| Prosthetic Reliance Question | Justification and Rationale |
|---|---|
| 16. Amputated side hip extension | Determines the patient's ability to maintain the prosthetic knee in extension |
| (Bilateral AK patient, score as a Left | during stance phase, as well as the ability to prevent the knee from |
| side hip extension) | initiating premature flexion. A high prosthetic reliance score indicates a |
| | limited ability to control the knee, which signifies a need for a prosthetic |
| | knee that will provide a high degree of stability and stumble recovery. |
| | The microprocessor knee servomotor readjusts the hydraulic flexion |
| | resistance from maximum powerful stance flexion resistance to nearly |
| | effortless knee bending to initiate pre-swing in less than 120 thousandths of |
| | a second. This feature offers secure stumble-recovery capabilities to ensure |
| | optimum knee resistance and stability in the event of a mis-step or stumble. |
| 17. Sound side hip extension | Determines the patient's strength and control of the contralateral hip, which |
| (Bilateral AK patient, score as a Right | is an indicator of the patient's overall balance and ability to transfer weight |
| side hip extension) | to the contralateral side. A high prosthetic reliance score indicates a limited |
| | ability to control the hip and suggests limited overall balance capabilities |
| | which signify a need for a prosthetic knee that will provide a high degree of |
| | stability and stumble recovery. |
| 18. Sound side knee extension | Determines the patient's strength and control of the contralateral knee, |
| (Bilateral AK patient, score 4) | which is an indicator of the patient's overall balance and ability to transfer |
| | weight during gait from the amputated side to the contralateral side. A high |
| | prosthetic reliance score indicates a limited ability to control the |
| | contralateral knee from premature flexion at heel strike, which will reduce |
| | stability and security during normal gait. This signifies a need for a |
| | prosthetic knee that will provide a high degree of stability and optimum |
| | stumble recovery during gait weight transfer. If the patient is a bilateral |
| | AK amputee, he/she will have no contralateral knee and therefore score 4 |
| | points. |
| 19. Sound side Ankle Plantar/Dorsi | Determines the patient's strength and control of the contralateral ankle, |
| Flexion | which is an indicator of the patient's overall balance, stability and ability to |
| (Bilateral AK or AK/BK patient, score | transfer weight during gait from the amputated side to the contralateral |
| 4) | side. A high prosthetic reliance score indicates a limited ability to control |
| | the contralateral foot and ankle at heel strike, which will reduce stability |
| | and security during normal gait. This factor signifies a need for a |
| | prosthetic knee that will provide a high degree of stability and optimum |
| | stumble recovery during gait weight transfer. If the patient is a bilateral |
| | lower limb amputee, he/she will have no contralateral ankle or foot and |
| | therefore score 4 points. |
| 20. Upper Extremity Strength | Determines the patient's overall strength and control of their upper limbs, |
| | which is an indicator of the patient's overall balance, stability and ability to |
| | function with ambulation aids (crutches, canes, walker). A high prosthetic |
| | reliance score indicates a limited ability to control the ambulation aids, |
| | which signifies a need for a prosthetic knee that will provide a high degree |
| | of stability and optimum stumble recovery. |

TABLE 7
Special Consideration
Special Consideration Evaluation

| | | |
|---|---|---|
| 21. | Hip Replacement (either side) | □ 1 |
| 22. | Unilateral Upper Extremity Amputation | □ 1 |
| 23. | Neuropathy on sound side | □ 1 |
| 24. | Asthma | □ 1 |
| 25. | Short Transfemoral amputation (less than 5″ femoral length) | □ 1 |
| 26. | Low Back or Hip Pain | □ 1 |
| 27. | Normal or Long Transtibial on contra lateral side (greater than | □ 2 |
| | 5″ tibial length) | |
| 28. | Hip disarticulation or Hemipelvectomy on affected side | □ 2 |
| 29. | Impaired Vision | □ 2 |
| 30. | Heart disease | □ 2 |
| 31. | Short Transtibial on contra lateral side (less than | □ 2 |
| | 5″ tibial length) | |
| 32. | Trans Femoral on contra lateral side (bilateral AK) | □ 3 |
| 33. | Bilateral Upper Extremity Amputation | □ 3 |
| | Special Consideration Score | |

The conditions listed in the sample Special Considerations category of Example 1 preferably is directed to specific medical conditions that may require or benefit from certain features of certain prosthetic devices more than someone without the medical condition. The Special Consideration score preferably provides a weighted value for unique and special conditions that a patient may exhibit. In the example of Table 7, each condition is weighted to a score of 1, 2 or 3, depending upon the severity of the condition and its subsequent effect on the patient's stability and ability to accomplish activities of daily living.

TABLE 8
Justification and Rationale for the Special Conditions

| Special Consideration Score | Score | Justification and Rationale |
|---|---|---|
| 21. Hip Replacement (either side) | 1 | Affects hip strength, control and balance which will impact |
| | | overall balance and ability to transfer weight during gait. |
| 22. Unilateral Upper Extremity | 1 | Affects overall balance and weight transfer during gait as well |
| Amputation | | as limits the ability to utilize ambulatory aids (crutches, |
| | | cane(s), walker, etc.). |
| 23. Neuropathy on sound side | 1 | Affects overall balance and weight transfer during gait due to |
| | | the lack of sensory feedback on the sound side. |
| 24. Asthma | 1 | Affects energy consumption and stress to the lungs and |
| | | potentially impacts the heart and blood pressure. Patient |
| | | requires optimum efficiency in gait to reduce energy |
| | | consumption. |
| 25. Short Transfemoral amputation | 1 | Creates added stress to the lower back and increases the |
| (less than 5″ femoral length) | | amount of energy and concentration for the patient to |
| | | maintain control of the socket and prosthesis. The short |
| | | residual limb reduces the patient's ability to maintain the |
| | | prosthetic knee in extension during stance phase requires |
| | | increase energy to prevent the knee from premature flexion. |
| 26. Low Back or Hip Pain | 1 | Impacts ability to initiate symmetrical weight transfer during |
| | | gait, which in turn increases energy consumption. Patient |
| | | requires a prosthesis that will minimize stress and strain to the |
| | | lower back to initiate weight transfer during the gait cycle as |
| | | well as reduce overall energy consumption. |
| 27. Normal or Long Transtibial on | 2 | Impacts overall balance and weight transfer during gait due to |
| contra lateral side (greater than 5″ | | the lack of sensory feedback and voluntary control of the |
| tibial length) | | sound side ankle and foot. |
| 28. Hip disarticulation or | 2 | Affects voluntary control of the prosthetic knee due to lack of |
| Hemipelvectomy on affected side | | residual limb and inability to control femoral flexion and |
| | | extension. |
| 29. Impaired Vision | 2 | Affects balance and influences ability to avoid objects during |
| | | gait. Patient requires additional support for stability and |
| | | stumble recovery. |
| 30. Heart disease | 2 | Affects energy consumption and stress to the heart and lungs. |
| | | Patient requires optimum efficiency in gait to reduce energy |
| | | consumption. |
| 31. Short Transtibial on contra-lateral | 2 | Impacts overall balance and weight transfer during gait due to |
| side (less than 5″ tibial length) | | the lack of sensory feedback and voluntary control of the |
| | | sound side ankle and foot. The short trans-tibial residual limb |
| | | also reduces control of the contra-lateral knee during weight |
| | | transfer, which reduces overall stability. |
| 32. Transfemoral on contralateral side | 3 | Impacts overall balance and weight transfer during gait due to |
| (bilateral AK) | | the lack of sensory feedback and voluntary control of the |
| | | knee, ankle and foot. |
| 33. Bilateral Upper Extremity | 3 | Affects balance and weight transfer during gait as well as |
| Amputation | | significantly limits the ability to utilize ambulatory aids |
| | | (crutches, cane(s), walker). Patient must rely on the |
| | | prosthetic devices for balance and stability as he/she has no |
| | | protection against injury in the event of a fall due to the lack |
| | | of upper limbs to prevent or catch themselves. |

Once the scores for each category is calculated, the final Evaluation Score can be obtained, for example, by adding each category's score. The final Evaluation Score of Example 1 is obtained by summing each category's score given above. Preferably the final Evaluation Score, referred to in Example 1 as the “Evaluation Validation Assessment Score” or “EVAS Score”, corresponds to a Status of the patient regarding the specific device, for example, whether or not the device is necessary or recommended.

More preferably, in accordance with an embodiment of the invention illustrated in the example, the system includes a secondary valuation for providing a more specific determination of a patient's needs. For example, as provided in Table 2 of Example 1, certain questions are considered “Cadence Score Questions”. These questions in Example 1 are directed toward long range walking and the ability for variable cadence and the ability to exceed faster than the baseline rate of walking. Accordingly, if the patient's final score is within a certain status, a more tailored care can be recommended and provided, depending on the patient's secondary score. For example, if a final score of 50 to 59 using the Example 1 evaluation indicates that the patient is a good candidate for a microprocessor knee. Furthermore, according to the patient's Cadence score, the most suitable microprocessor knee component can be determined.

Table 9 shows the assessment of the final Evaluation Score and the rationalization for each Status according to Example 1. The microprocessor controlled knee components referred to in Table 9 are products sold under the trade names “Compact” and “C-Leg®” by Otto Bock®, a German corporation; the Knee® by Ossur, an Iceland corporation; and Adaptive Knee by Endolite, an Ohio corporation.

TABLE 9
Final Evaluation Score

| Score | STATUS | Rationalization |
|---|---|---|
| <40 | Not a Candidate | An EVAS Score under 40 would indicate a low ADL and |
| | Microprocessor Knee not required | Functional score in addition to a lack of sufficient Special |
| | | Consideration points to justify a microprocessor knee. A |
| | | score below 40 would suggest the patient is sedentary and |
| | | lacks the ability to perform specific functions to achieve a |
| | | high level of activities of daily living. |
| 40-49 | MPK Stance Indicated | An EVAS score between 40 and 49 would indicate a median |
| | Otto Bock ®'s Compact | score for ADL's, Function, and Prosthetic Reliance. This |
| | | score would suggest the patient requires a higher activity level |
| | | to accomplish ADL's and also displays the ability to perform |
| | | the required functions. Typically a score between 40-49 will |
| | | also indicate the patient will have a higher Prosthetic Reliance |
| | | score and requires the microprocessor knee to provide |
| | | maximum stability and security to enable the patient to |
| | | accomplish activities of daily living (ADL's). |
| 50-59 | MPK Knee Indicated | An EVAS score between 50 and 59 would indicate the patient |
| | Cadence score 14 and below | has above average ADL and Functional scores and below |
| | Otto Bock ®'s Compact | median prosthetic reliance scores. This patient may also score |
| | Cadence score 15 and above | additional points for special consideration. This patient |
| | Otto Bock ®'s C-Leg ® | presents as a good candidate for a microprocessor knee as |
| | Ossur's Rheo Knee ™ | he/she demonstrates the functional and physical ability to |
| | | require this technology to accomplish activities of daily |
| | | living. The indicator to provide additional MPK Swing phase |
| | | control is determined by the patient's cadence score on select |
| | | EVAS questions focusing on long range walking and the |
| | | ability for variable cadence and to exceed faster than baseline |
| | | rate of walking. |
| 60-72 | MPK Swing & Stance Indicated | An EVAS score between 60 and 72 would indicate the patient |
| | Otto Bock ®'s C-Leg ® | is an excellent candidate for a microprocessor knee. This |
| | Ossur's Rheo Knee ™ | score would suggest the patient has a high ADL and |
| | Endolite's Adaptive Knee | Functional score and a below median Prosthetic Reliance |
| | | score. That would indicate that the patient requires a |
| | | microprocessor knee to enable him/her to achieve an active |
| | | lifestyle in achieving activities of daily living. |
| 72> | Score over 72 indicates a possible | An EVAS Score above 72 is highly unlikely. If ADL score |
| | discrepancy in scoring and the | were 40 and Functional score were 20, this would indicate a |
| | EVAS should be re-evaluated. | strong and active individual and therefore the Prosthetic |
| | | Reliance score should be low to mid range (0-10). It is |
| | | exceedingly unlikely that a highly active (ADL = 40) and |
| | | highly functional patient (FL = 20) would also score very high |
| | | on the special consideration and Prosthetic Reliance category. |
| | | Any score over 72 should be audited and re-evaluated to |
| | | ensure compliance and evaluation accuracy. |

In a preferred embodiment of the invention, various ranges of the final Evaluation Score correspond to different patient status and therefore recommendation regarding the device.

Preferably, the information obtained can be used by entities, such as insurance companies or other entities who grant or deny the requested care, as a more objective basis for granting or denying the care requested, compared to the prior art. More specifically, an insurance company can decide that all care or component will be granted if a threshold final Evaluation Score is met, such as a final Evaluation Score that denotes a recommendation or greater. For example, an insurance company deciding whether or not to provide a microprocessor knee servomotor can use Example 1 and grant the request for patients having a final Evaluation Score of 50 or greater. By providing specific standards and guidelines for deciding whether or not to provide a patient with the requested care or component, the present invention further provides the deciding entities more confidence in their decisions and speeds up the process.

It will be understood that while fundamental novel features of the invention as applied to preferred embodiments and examples thereof have been described and pointed out, various omissions and substitutions and changes in the form and details of the disclosed invention may be made by those skilled in the art without departing from the spirit of the invention. For example, whereas the embodiment described comprises categories, the invention can comprise a plurality of questions, each having its own method of scoring the patient, without deviating from the scope of the invention. The invention can also comprise more than one group of secondary valuation questions, each group preferably used to determine the suitability of a common or different treatment. Additionally, the invention is not limited to a microprocessor controlled knee but can be applied to any clinical care or prosthetic or orthotic component. For example, the invention can be used to determine the appropriateness of certain prosthetics such as arm prosthetics. The invention can also be used to ascertain the suitability of certain treatments for certain patients. It is the intention, therefore, to be limited only as indicated by the scope of the claims appended hereto.

1. A method for determining the qualifications of a patient for a specific care or component comprising:
gathering scores for a plurality of categories comprising one or more questions directed to one or more characteristics of a patient;
using the scores for each category to obtain a final score;
evaluating the final score to determine the qualifications of the patient for a specific care or component.

2. The method according to claim 1, wherein evaluating the final score comprises comparing the final score to an evaluation chart comprising a variety of ranges of the final score corresponding to respective patient qualifications.

3. The method according to claim 1, wherein the final score comprises the sum of the scores of each category.

4. The method according to claim 1, wherein the plurality of categories comprises a category directed to the patient's daily activities.

5. The method according to claim 1, wherein the plurality of categories comprises a category directed to the patient's functional requirements in accordance with the Medicare functional level requirements.

6. The method according to claim 1, wherein the plurality of categories comprises a category directed to the patient's physical capabilities.

7. The method according to claim 6, wherein the patient's physical capabilities comprises the patient's reliance on a prosthetic device.

8. The method according to claim 1, wherein the plurality of categories comprises a category directed to the patient's medical conditions.

9. The method according to claim 1, wherein the component is a microprocessor controlled knee component.

10. The method according to claim 1, wherein the scores for a plurality of categories comprise at least one secondary score for selected questions.

11. The method according to claim 10, wherein the selected questions are directed to one or more specific capabilities of the patient.

12. The method according to claim 10, wherein the at least one secondary score for at least one of the selected questions are evaluated to determine the qualifications of the patient for a specific care or component.

13. A method for determining the qualifications of a patient for a specific care or component comprising:
gathering primary scores for a plurality of categories comprising one or more questions directed to one or more characteristics of a patient;
gathering one or more secondary scores for selected questions directed to one or more specific capabilities of the patient;
using the primary scores for each category to obtain a primary final score;
using the one or more secondary scores to obtain one or more secondary final scores;
evaluating the primary final score and the one or more secondary final scores to determine the qualifications of the patient for a specific care or component.

14. The method according to claim 13, wherein evaluating the primary final score and the one or more secondary final scores comprises comparing the primary final score to an evaluation chart comprising a variety of ranges of the primary final score corresponding to respective patient qualifications, and comparing the one or more secondary final scores to a variety of ranges of one or more secondary final scores within one or more of the ranges of the primary final score.

15. A method for determining the qualifications of a patient for a specific care or component comprising:
gathering scores for a plurality of questions directed to one or more characteristics of a patient;
using the scores to obtain a final score;
evaluating the final score to determine the qualifications of the patient for a specific care or component.
